(19) United States
(12) Patent Application Publication
(10) Pub. No.: US 2003/0021210 A1
(43) Pub. Date: Jan. 30, 2003

(54) Record carrier and method and recording apparatus for recording thereon

(76) Inventor: Cornelis Marinus Schep, Eindhoven (NL)

Correspondence Address: U.S. Philips Corporation, 580 White Plains Road, Tarrytown, NY, 10591, US

(21) Appl. No.: 10/196,048

(22) Filed: Jul. 15, 2002

(30) Foreign Application Priority Data
Jul. 18, 2001 (EP) 01202728.0

(51) Int. Cl. G11B 7/0045

(52) U.S. Cl. 369/59.25; 369/59.26

(57) ABSTRACT

The present invention relates to a record carrier and a method and a recording apparatus for recording thereon. Information is recorded on the record carrier in units of recording blocks (RBx). Two successive and adjacent recording blocks are linked by a data linking area comprising a prost-amble field (PoA), two guard fields (G1, G2) and a pre-amble field (PrA). On the record carrier according to the invention, the recording blocks, or alternatively the guard fields, are recorded such that the data linking area does not comprise any gap area. This allows for less disturbance of the signal obtained from scanning the record carrier and for an increased of the storage capacity of the record carrier.

The present invention relates to a record carrier suitable for recording information thereon, the record carrier provided with at least one recording track, the information being recorded on the recording track in units of recording blocks, a first linking field recorded at the end of a first recording block and a second linking field recorded at the start of a second recording block, the first recording block preceding and adjacent to the second recording block.

The invention also relates to a method for recording information on such a record carrier provided with at least a first recording block and a corresponding first linking field recorded on the recording track, the method comprising a recording step of recording a second recording block and a corresponding second linking field on the recording track, the second recording block being subsequent and adjacent to the first recording block, and also to a recording apparatus for recording information on such a record carrier provided with a first recording block and a corresponding first linking field recorded on the recording track, the recording apparatus comprising recording means for scanning the recording track and for recording a second recording block and a corresponding second linking field, and control means for controlling said recording unit so as to record said second recording block and said corresponding second linking field on the recording track subsequent and adjacent to the first recording block.

First examples of such a record carrier suitable for recording information are a CD and DVD Recordable (CD-R, DVD-R). Information is recorded by irradiating a recording layer of the record carrier by a radiation beam such as, for example, a laser light beam which is focussed on the recording layer. When the radiation beam has a write power level, marks in the form of pits or of areas with locally changed optical properties are formed in the recording layer. By modulating the radiation beam between the write power level and a power level incapable of forming marks, a sequence of marks is recorded representing the information to be recorded. A second example of a record carrier suitable for recording information is a record carrier comprising a recording layer of the phase-change type, such as for example CD and DVD Rewritables (CD-RW, DVD-RW). Information is recorded on such a record carrier by irradiating the recording layer by a radiation beam having a write power level causing the recording layer to locally change from a first stable phase to a second stable phase, thus forming a mark. Again, information is recorded by modulating the radiation beam, thus forming a sequence of marks representing the information to be recorded. However, recorded marks can now be erased by irradiation of the phase-change type recording layer by means of a radiation beam having an erase power level lower than the write power level. An example of a phase-change recording layer is a recording layer having a crystalline first stable phase and an amorphous second stable phase.

The recorded information is read back by scanning the recording track. A radiation beam, having a read power level, is focussed onto the recording layer of the record carrier along the recording track and the radiation reflected from the marks and the areas between the marks is detected. The detected radiation reflected from the record carrier is converted into one ore more electric signals representing the recorded information being read. It is be noted that the recording track may be formed by a convex circular or spiral area on the recording layer, by a concave circular or spiral area on the recording layer, or, alternatively, by a combination of both a convex and a concave circular or spiral area on the recording layer.

A record carrier according to the preamble is known from “Format description and evaluation of the 22.5 GB Digital-Video-Recording disc”, Kees Schep et.al, Jpn. J. Appl. Phys., Vol. 40 (2001), pp. 1813-1816, describing the format of a rewritable record carrier for use in a digital-video-recording (DVR) system. Information is recorded on the known record carrier in recording blocks , the so-called ECC blocks (in the DVR system also known as “Data Recording Frames” and in DVD systems as “SYNC Frames”). Two successive ECC blocks are linked together using a first linking field, i.e. a data run-out field, and a second linking field, i.e. a data run-in field. The data run-out field and the data run-in field comprise well-defined patterns of marks. Furthermore, a gap is provided between two successive ECC blocks, that is, in between the data run-out field and the data run-in field. The area consisting of the data run-out field, the gap and the data run-in field is referred to as the data linking area.

When information is recorded in adjacent areas in a recording track on the record carrier, the information to be recorded has to be linked with the information already recorded on the record carrier in a controlled way to ensure the validity of both the already recorded information as well as the newly recorded information. For example, the newly recorded information should not be written over the user information already recorded. For this purpose, the linking area is provided between two successive recording blocks on a recording track. The first linking field, i.e. the data run-out field, guarantees a clean termination of the recording process while the second linking field, i.e. the data run-in field, is used to settle the detection electronics during read out. The gap is provided as a spatial separation between the two recording blocks.

However, the gap between two successive recording blocks has the disadvantage that it adversely effects control signals in recording devices for recording information on the record carrier and in reading devices for reading recorded information from the record carrier. Such devices in general comprise means for positioning the focal spot of the radiation beam along the track. These means use signals obtained from radiation reflected from marks and areas between the marks on the recording layer of a record carrier for controlling the position of the focal spot. A relatively large area without any mark, such as the gap between two successive recording blocks, adversely affects this control. After a gap, an relatively large area with a pattern of marks is required to settle the servo control. Moreover, signal processing electronics is in general dynamically adjusted to ensure optimal settings by analyzing the input signal obtained from reading the recorded information. After a period without any information in the input signal, caused by reading a gap, optimal settings of the signal processing electronics is obtained only after a certain amount of information has been read. To ensure correct read out of user information, a gap is, in general, followed by a relatively large area comprising a pattern of marks representing dummy data allowing the electronics to be set to their correct settings again before the user information is read.

It is an object of the present invention to provide a record carrier in which the described disadvantage is avoided without significantly increasing the complexity of the record carrier.

This object is achieved when the record carrier according to the preamble is characterized in that said first and second recording blocks are located on the recording track such that the start position of the second linking field is located within the area of the first linking field. In this way the gap area between adjacent recording blocks is avoided. The linking area between two adjacent recording blocks now consists of a first linking field and a second linking field without a gap in between. When scanning the recording track, the control-signals will not be adversely effected. Moreover, it is an additional advantage of the record carrier according to the invention that the overhead caused by the date linking area is reduced, thus increasing the capacity of the record carrier for recording user information. This reduced overhead of the data linking area is obtained because no space is used for gaps. Moreover, because there is no longer a need to resettle the electronics after a gap, the length of the second linking field, such as the data run-in field on a record carrier used in a DVR-system, may be reduced.

The object is alternatively achieved when the record carrier according to the preamble is characterized in that said linking fields have lengths such that the start position of the second linking field is located within the area of the first linking field. Again, by selecting appropriate lengths of the linking fields, the gap between adjacent recording blocks on a recording track is avoided.

It is a further object of the invention to provide a method for recording information on a record carrier according to the invention.

This object is achieved by providing a method of recording information as defined in claim 3 or, alternatively, in claim 4.

It is a still further object of the invention to provide a recording apparatus for use with a record carrier according to the invention.

This object is achieved by providing a recording apparatus as defined in claim 5 or, alternatively, in claim 6.

These and other aspects of the invention will be come apparent from and elucidated further with reference to the embodiments described, by way of example, in the following description and with reference to the accompanying drawings, in which

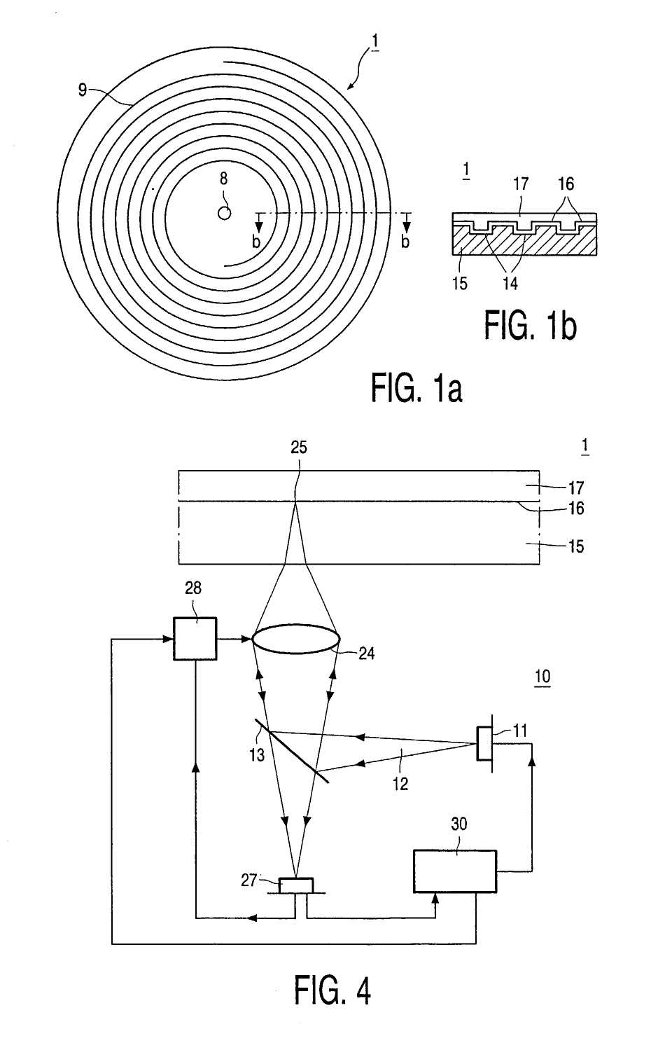

FIG. 1 shows a record carrier,

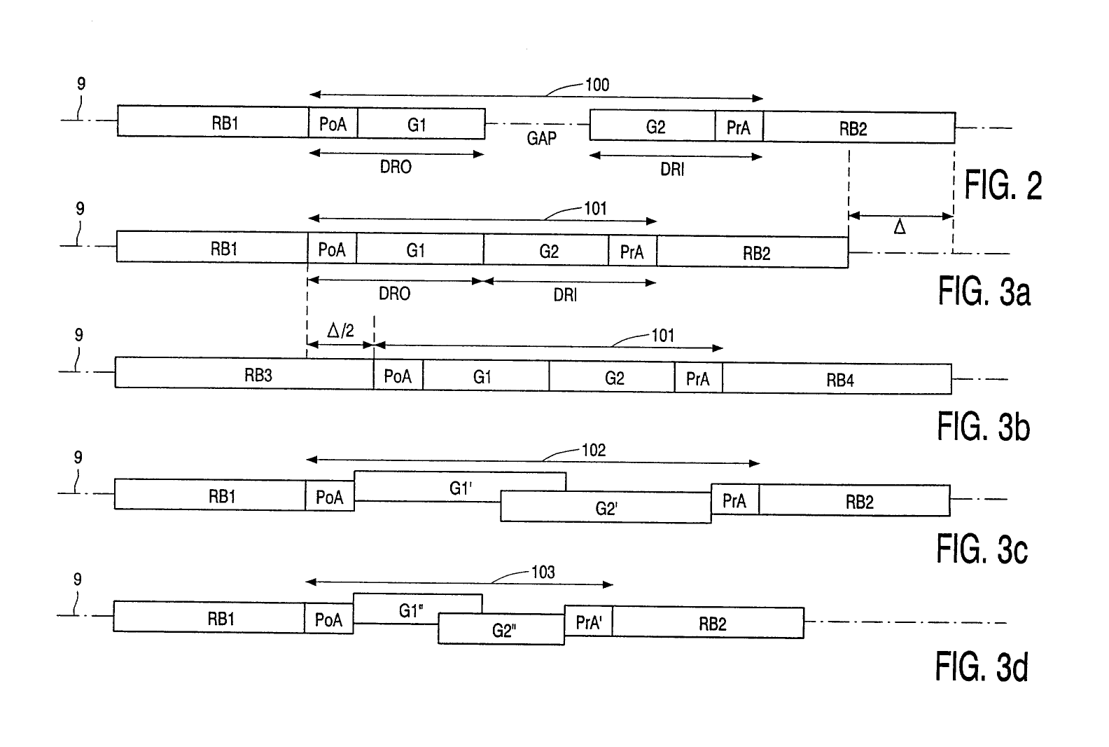

FIG. 2 is a schematic representation of a part of a record carrier according to the prior art with a data link area,

FIG. 3 shows schematic representations of a part of the record carrier according to the invention with data linking areas according to several embodiments of the invention, and

FIG. 4 shows an embodiment of a recording apparatus according to the invention.

FIG. 1a shows a disc-shaped record carrier 1 having a recording track 9 and a central hole 8. The recording track 9 is arranged in accordance with a spiral pattern of turns constituting substantially parallel tracks on an recording layer. The record carrier may be optically readable (called an optical disc) and have a recording layer of a recordable type, such as a CD-R or DVD-R disc, or of a rewritable type, such as a CD-RW, DVD-RW or DVR disc. The recording track structure is constituted, for example, by a pregroove 14 which enables a read/write head to follow the recording track during scanning. The information is represented on the recording layer by a pattern of optically detectable marks along the recording track 9. The information is recorded along the recording track 9 in units of recording blocks.

FIG. 1b is a cross-section taken along the line b-b of the record carrier 1 in which a transparent substrate 15 is provided with a recording layer 16 and a protective layer 17. The protective layer may comprise a further substrate layer, for example as in DVD where the recording layer is provided on a 0.6 mm substrate and a further substrate of 0.6 mm is bonded to the back side thereof. The pregroove 14 may be implemented as an indentation, i.e. a concave area, or an elevation, i.e. a convex area, of the substrate 15 material or as a material property deviating from its surroundings. Moreover, although only a single recording layer 16 is shown, the record carrier 1 may comprise multiple recording layers with separator layers in between.

FIG. 2 is a schematic representation of a part along the recording track 9 including a first recording block RB1, a second recording block RB2 and a data linking area 100 according to the prior art. A first linking field, data run-out field DRO, is recorded at the end of the first recording block RB1 and a second linking field, data run-in field DRI, is recorded at the start of the second recording block RB2. A gap GAP is located in between the first linking field (data run-out field DRO) and the second linking field, (data run-in field DRI). The data linking area 100 comprises successively the first linking field, i.e.the data run-out field DRO, the gap area GAP and the second linking field, i.e. the data run-in field DRI.

The linking fields DRO and DRI comprise in general at least two distinguishable areas. Often, a postamble field PoA comprising a specific pattern to signal the end of the user information is provided at the start of the first linking field DRO between the user information in the first recording block RB1 and a guard field G1 in the first linking field DRI. Likewise, a preamble field PrA comprising a pattern to signal the start of the user information may be provided between a guard field G2 in the second linking field and the user information in the second recording block RB2. The guard fields G1 and G2 may contain dummy data. Alternatively, these guard fields may contain a predetermined pattern of marks chosen such that this pattern is well suited to re-settle the electronic circuits.

FIG. 3 shows schematic representations of a part along the recording track 9 on a record carrier according to the invention, including a first recording block, an adjacent second recording block and a linking area in between the two recording blocks. FIG. 3a shows a schematic representation of a part along the recording track 9 on a record carrier according to a first embodiment of the invention. The second recording block RB2 is positioned along the recording track 9 such that the start position of the second linking field DRI is located at the end of the area of the first linking field DRO. The data linking area 101 does not comprise a gap area. A radiation beam scanning the recording track 9 will not pass an area without marks when going from the first recording block RB1 to the second recording block RB2. Therefore the control signals derived from the reflected radiation beam will not be adversely affected.

Although the lengths of the recording blocks (RB1 and RB2) and of the linking fields (DRO and DRI) recorded on the record carrier according to the invention are equal to the lengths of the recording blocks and of the linking fields recorded on a record carrier known from the prior art, the total length of a first recording block RB1 and a data linking area 101 and a second data recording block RB2 on the record carrier according to the invention is reduced by an amount of A in comparison with the total length of a first recording block RB1 and a data linking area 100 and a second data recording block RB2 on a record carrier known from the prior art. Because of this, a larger number of recording blocks can be recorded on a recording track of a record carrier according to the invention than on a recording track of a record carrier known from the prior art, both recording tracks being of the same length. The storage capacity of a record carrier for recording user information is thus increased.

An alternative embodiment is shown in FIG. 3b. Again, the second recording block RB4 is positioned along the recording track 9 such that the start position of the second linking field DRI is located at the end of the area of the first linking field DRO. However, instead of increasing the storage capacity of the record carrier to record user information by recording a larger amount of recording blocks, each of the recording blocks RB3 and RB4 now comprises a larger amount of user information than the recording blocks RB1 and RB2. In this way the linking overhead, i.e. the length of the data linking area in respect to the length of a recording block, is reduced. In the embodiment schematically shown in FIG. 3b, the recording block RB3 is an amount of Δ/2 longer than the recording block RB1 in FIG. 3a.

FIG. 3c shows a schematic representation of a part along the recording track 9 on a record carrier according to a further embodiment of the invention. A first recording block RB1 is linked to a second recording block RB2 by a first linking field, composed of a postamble field PoA and a guard field G1′, and a second linking field, composed of a preamble field PrA and a guard field G2′. The length of the guard field G1′, and hence the length of the first linking field, and of guard field G2′, and hence the length of the second linking field, are set such that the guard field G2′ overlaps the guard field G1′. The start position of the guard field G2′ is thus located within the area of the guard field G1′. The data linking area 102 now comprises successively the post-amble field PoA, the guard field G1′ not overwritten by the guard field G2′, the guard field G2′ and the pre-amble field PrA. It is advantageous to start the recording of the guard field G2′ well within the area of the guard field G2′, because it prevents the formation of a gap area without the need to position the start of the second linking field over the end position of the first linking field.

FIG. 3d shows a schematic representation of a part along the recording track 9 on a record carrier according to a further embodiment of the invention. Guard field G1″ is now reduced in length compared to guard field G1″ and guard field G2″ is reduced in length compared to guard field G2′. Because there is no gap area in the data linking area 103, there is no need for a relatively large area comprising a pattern of marks allowing the electronics to be set to their correct settings again before the user information is read. The length of the guard fields, used primarily for re-settling the electronics, may, therefore, be reduced. The storage capacity of the record carrier for recording user information is thus increased. An even further increase of the storage capacity may be obtained by reducing the length of the pre-amble field.

FIG. 4 shows an embodiment of a recording apparatus 10 for recording information on a record carrier 1 according to the invention. The recording apparatus 10 comprises a radiation source 11, such as, for example, a diode laser which generates a radiation beam 12, such as, for example, a laser light beam. The radiation beam is formed to a focussing spot 25 on the recording layer 16 of the record carrier 1 via a beam splitter 13, for example, a semitransparent plate, and a lens system 24, for example, an objective lens. By rotating the record carrier 1 about its center the entire recording track 9 can be scanned by the focussing spot 25. The radiation reflected by the recording layer is modulated by the recorded information into, for example, an intensity or direction of polarization of the reflected radiation beam. The objective lens 24 and the beam splitter 13 guide the reflected radiation towards a detection system 27 which converts the incident radiation into one or more electric signals. One of these signals has a modulation which is related to the information being read. Other electric signals are used for controlling the recording apparatus, such as an electric signal indicating the position of the focussing spot 25 with respect to the track being scanned. The latter electric signal is applied to a servo system 28 which controls the position of the objective lens 14 and hence the position of the focussing spot 25 in the plane of the recording layer 16 and in the direction perpendicular thereto in such a way that the focussing spot 25 follows the desired recording track 9 in the plane of the recording layer. The recording means, comprising the radiation source 11, the beam splitter 13, the lens system 24, the detection system 27 and the servo system 28, are controlled by a control unit 30 which ensures correct scanning of the record carrier 1. This control unit is, inter alia, used for controlling recording and erasing information in the record carrier 1.

The control unit 30 is programmed such that when a second recording block is to be recorded on the recording track 9 of a record carrier 1 subsequent and adjacent to a previously recorded first recording block, this second recording block is recorded on the record carrier according to any one of the embodiments shown in FIG. 3 and described above. The control unit 30 is programmed such that after the second recording block has been recorded, a data linking area linking the first recording block and the second recording block does not comprise a gap area. This is, for example, achieved by controlling the recording so that the second recording block is positioned on the recording track such that the start position of the second linking field is located at the end position of the first linking field (see FIG. 3a), or, alternatively, by controlling the recording so that the length of the second linking field is set to a value such that the start position of the second linking field is located well within the area of the first linking field (see FIG. 3c).

It is to be noted that the present invention is not restricted to an optical disc and to a recording apparatus for recording information on such an optical disc as described in the embodiments above, but relates also to other types of record carriers such as, for example, a record carrier provided with a magnetic or electric recording layer, and to recording apparatuses for recording on other types of record carriers. The embodiments presented may vary within the scope of the attached claims.

1. A record carrier suitable for recording information thereon, the record carrier provided with at least one recording track, the information being recorded on the recording track in units of recording blocks, a first linking field recorded at the end of a first recording block and a second linking field recorded at the start of a second recording block, the first recording block preceding and adjacent to the second recording block, characterized in that said first and second recording blocks are located on the recording track such that the start position of the second linking field is located within the area of the first linking field.

2. A record carrier suitable for recording information thereon, the record carrier provided with at least one recording track, the information being recorded on the recording track in units of recording blocks, a first linking field recorded at the end of a first recording block and a second linking field recorded at the start of a second recording block, the first recording block preceding and adjacent to the second recording block, characterized in that said linking fields have lengths such that the start position of the second linking field is located within the area of the first linking field.

3. A method for recording information on a record carrier suitable for recording information thereon, the information being recorded in units of recording blocks, a first linking field being recorded at the end of a recording block and a second linking field being recorded at the start of a recording block, said record carrier provided with at least one recording track, a first recording block and a corresponding first linking field recorded on said recording track, the method comprising
a recording step for recording a second recording block and a corresponding second linking field on the recording track, the second recording block being subsequent and adjacent to the first recording block,
characterized in that the method also comprises a positioning step for positioning the first and second recording blocks such that the start position of the second linking field is located within the area of the first linking field.

4. A method for recording information on a record carrier suitable for recording information thereon, the information being recorded in units of recording blocks, a first linking field being recorded at the end of a recording block and a second linking field being recorded at the start of a recording block, said record carrier provided with at least one recording track, a first recording block and a corresponding first linking field recorded on said recording track, the method comprising
a recording step for recording a second recording block and a corresponding second linking field on the recording track, the second recording block being subsequent and adjacent to the first recording block,
characterized in that the method also comprises a setting step for setting the lengths of said first and/or of said second linking field such that the start position of the second linking field is located within the area of the first linking field.

5. A recording apparatus for recording information on a record carrier suitable for recording information thereon, the information being recorded in units of recording blocks, a first linking field being recorded at the end of a recording block and a second linking field being recorded at the start of a recording block, said record carrier provided with at least one recording track, a first recording block and a corresponding first linking field being recorded on said recording track, the recording apparatus comprising
recording means for scanning the recording track and for recording a second recording block and a corresponding second linking field, and
control means for controlling said recording unit so as to record said second recording block and said corresponding second linking field on the recording track subsequent and adjacent to the first recording block,
characterized in that the control means control the recording means so as to position said second recording block such that the start position of the second linking field is located within the area of the first linking field.

6. A recording apparatus for recording information on a record carrier suitable for recording information thereon, the information being recorded in units of recording blocks, a first linking field being recorded at the end of a recording block and a second linking field being recorded at the start of a recording block, said record carrier provided with at least one recording track, a first recording block and a corresponding first linking field recorded on said recording track, the recording apparatus comprising
recording means for scanning the recording track and for recording a second recording block and a corresponding second linking field, and
control means for controlling said recording unit so as to record said second recording block and said corresponding second linking field on the recording track subsequent and adjacent to the first recording block,
characterized in that the control means control the recording means so as record the second linking field with a length such that the start position of the second linking field is located within the area of the first linking field.
